(19) United States
(12) Patent Application Publication
(10) Pub. No.: US 2025/0229518 A1
(43) Pub. Date: Jul. 17, 2025

(54) PRESS BONDING APPARATUS FOR ELECTRODE FOIL OF A LITHIUM METAL SECONDARY BATTERY

(71) Applicants: InnoRex Inc., Cheonan-si (KR); TOP MATERIAL Co., Ltd., Icheon-si (KR)

(72) Inventors: Ji Hoon CHO, Asan-si (KR); Jong Ho Seok, Icheon-si (KR); Min Chul Kim, Icheon-si (KR)

(21) Appl. No.: 18/750,146

(22) Filed: Jun. 21, 2024

(30) Foreign Application Priority Data
Jan. 12, 2024 (KR) 10-2024-0005680

(51) Int. Cl. B32B 37/00; B32B 41/00; H01M 4/04

(52) U.S. Cl. CPC B32B 37/0053; B32B 41/00; H01M 4/0435; B32B 2457/10

(57) ABSTRACT

The present disclosure relates to a press bonding apparatus for an electrode foil of an all-solid-state secondary battery including an asymmetric rolling press element that may precisely adjust the supply speed and rolling speed while preventing damage to metal foils, thereby improving the uniformity and coating flatness of the electrode foil.

### CROSS REFERENCE TO RELATED APPLICATION

This application is based on and claims priority under 35 U.S.C. § 119 to Korean Patent Application No. 10-2024-0005680 filed on Jan. 12, 2024 in the Korean Intellectual Property Office, the disclosure of which is incorporated by reference herein in its entirety.

### TECHNICAL FIELD

The present disclosure relates to an apparatus capable of manufacturing an electrode foil assembly by press bonding an electrode foil for a lithium metal battery.

### BACKGROUND

Lithium metal batteries have a different structure and principle from common battery technologies such as lithium-ion batteries.

The electrode foils are electrodes with an electrically positive charge. The electrode foil is mainly composed of a substance known as electrode active material or electrode foil material.

The electrode foil material needs to be a recyclable substance that may be stored and returned by inserting lithium ions. The electrode foil material needs to be electrically active and be capable of carrying out reactions that may accept and release lithium ions. These reactions may be decided by the chemical properties of an electrode material.

Korean Patent Application Publication No. 10-2022-0067385 discloses manufacturing of such a solid electrolyte. However, this related art is configured to manufacture an electrode foil active substance by coating a solid electrolyte, but there is an issue in securing uniformity and coating flatness.

### SUMMARY

An aspect of the present disclosure is directed to providing a press bonding apparatus for an electrode foil of a lithium metal secondary battery, thereby addressing an issue of not securing the uniformity and coating flatness of conventional electrode manufacturing apparatus.

There is provided the press bonding apparatus for the electrode foil of the a lithium metal secondary battery, wherein the apparatus includes: a base metal transfer unit configured to transfer a base metal foil to a press bonding space; a first transfer unit configured to transfer a first lithium metal foil to the press bonding space; a second transfer unit configured to transfer a second lithium metal foil to the press bonding space; a hard roller provided on one side of the press bonding space; and an elastic roller provided on the other side of the press bonding space, wherein the hard roller and the elastic roller may press-bond the base metal foil, the first lithium metal foil, and the second lithium metal foil.

The elastic roller may include a roller core and a coating unit provided on an outer peripheral surface of the roller core.

Additionally, there may be further included a pressing drive unit configured to press the elastic roller toward the hard roller.

There may be further included an encoder configured to measure the rotation of the hard roller.

There may be further included a rotation drive unit configured to rotate the elastic roller.

Additionally, the hard roller may be configured to freely rotate.

The base metal transfer unit may include a first sensor unit configured to measure a moving speed of the base metal foil, and a controller configured to control the rotation drive unit based on a value received from the first sensor unit.

Additionally, the controller may be configured to control the rotation drive unit based on the value received from the first sensor unit and a value received from the encoder.

There may be further included a tack laminating module configured to cut the first lithium metal foil transferred from the first transfer unit and the second lithium metal foil transferred from the second transfer unit and tack laminate ends of the proceeding lithium metal foil to both surfaces of the base metal foil.

The tack laminating module may be composed of a pair, be symmetrical on the left and right, and include blades that are each reciprocatable.

Additionally, the tack laminating module may be configured to cut the first lithium metal foil and the second lithium metal foil to a predetermined length.

The tack laminating module may be controlled to tack laminate front ends of the proceeding first lithium metal foil and the proceeding second lithium metal foil at a predetermined distance apart from rear ends of the preceding first lithium metal foil and the second lithium metal foil.

The press bonding apparatus for the electrode foil of the lithium metal secondary battery according to an embodiment of the present disclosure can improve the uniformity and coating flatness of an electrode assembly.

This invention can be utilized not only for the production of lithium metal batteries but also for the manufacture of solid-state batteries.

### BRIEF DESCRIPTION OF THE DRAWINGS

FIG. 1 is a perspective view of an electrode foil manufactured according to an embodiment of the present disclosure.

FIG. 2 is a front view of an apparatus for manufacturing a secondary battery provided with a press bonding apparatus for an electrode foil of a lithium metal secondary battery according to an embodiment of the present disclosure.

FIG. 3 is a perspective view of a press bonding apparatus according to an embodiment of the present disclosure.

FIG. 4 is an exploded perspective view of the press bonding apparatus according to an embodiment of the present disclosure.

FIG. 5 is a conceptual diagram illustrating the operation of an elastic roller and a hard roller in the press bonding apparatus for the electrode foil of the lithium metal secondary battery according to an embodiment of the present disclosure.

FIG. 6 is a conceptual diagram illustrating the deformation of the elastic roller in an embodiment of the present disclosure.

FIG. 7 is a conceptual diagram illustrating the speeds of foils, elastic rollers, and hard rollers in a pressing area in an embodiment of the present disclosure.

FIGS. 8A, 8B, 8C, 8D, 8E, 8F, 8G, 8H and 8I are operational state views of the press bonding apparatus for the electrode foil of the lithium metal secondary battery according to an embodiment of the present disclosure.

### DETAILED DESCRIPTION

Hereinafter, a press bonding apparatus for an electrode foil of a lithium metal secondary battery according to an embodiment of the present disclosure will be described in detail with reference to the accompanying drawings. In addition, in the following description of the embodiments, constituents may each be named differently in the pertinent field. However, if the constituents have functional similarity and identity, they may be considered to be equivalent configurations although modified embodiments are adopted. Furthermore, reference numerals assigned to respective constituents are written for convenience of description. However, contents illustrated in the drawings in which the reference numerals are written do not restrict respective constituents to the ranges in the drawings. Likewise, although the configurations in the drawings adopt partially modified embodiments, they may be considered to be equivalent configurations if the constituents have functional similarity and identity. Furthermore, a description of a constituent is omitted if the constituent is recognized as being a constituent that needs to be naturally included in view of the level of a person having ordinary skill in the pertinent technical field.

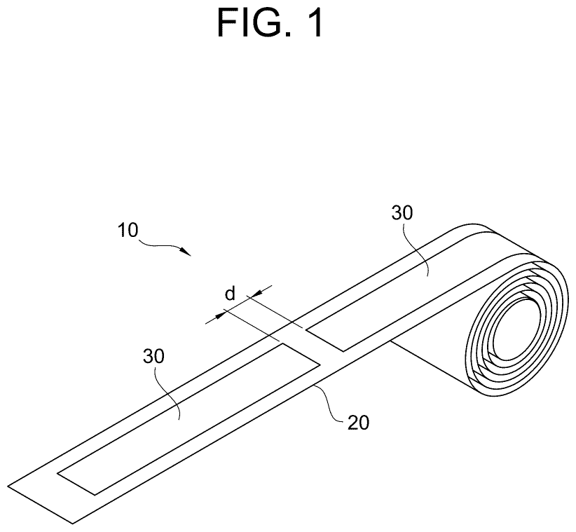

FIG. 1 is a perspective view of an electrode foil manufactured according to an embodiment of the present disclosure.

Referring to FIG. 1, the electrode foil manufactured according to an embodiment of the present disclosure may have a lithium metal foil cut to a predetermined length attached to a base metal foil 20. The lithium metal foil may be attached to both surfaces of the base metal foil 20, and may be attached symmetrically around the base metal foil 20. The lithium metal foil may be continuously disposed at predetermined intervals d along a length direction of the base metal foil 20. The electrode foil (hereinafter referred to as ‘electrode assembly 10’) manufactured in an electrode foil manufacturing apparatus according to an embodiment of the present disclosure may be used after being cut to a predetermined size in a separate apparatus for manufacturing a lithium metal secondary battery. In other words, an apparatus for manufacturing electrode foils of a lithium metal secondary battery according to an embodiment of the present disclosure may continuously manufacture electrode foils as a prior stage in manufacturing a lithium metal secondary battery.

In an embodiment of the present disclosure, the base metal foil 20 is an electrode foil of a lithium metal secondary battery, and may be composed of various metal elements, and as an example, may be composed of copper (Cu). Additionally, a lithium metal foil 30 may be composed of lithium (Li) and may be composed of a mixture of various elements to improve the performance of the lithium metal secondary battery.

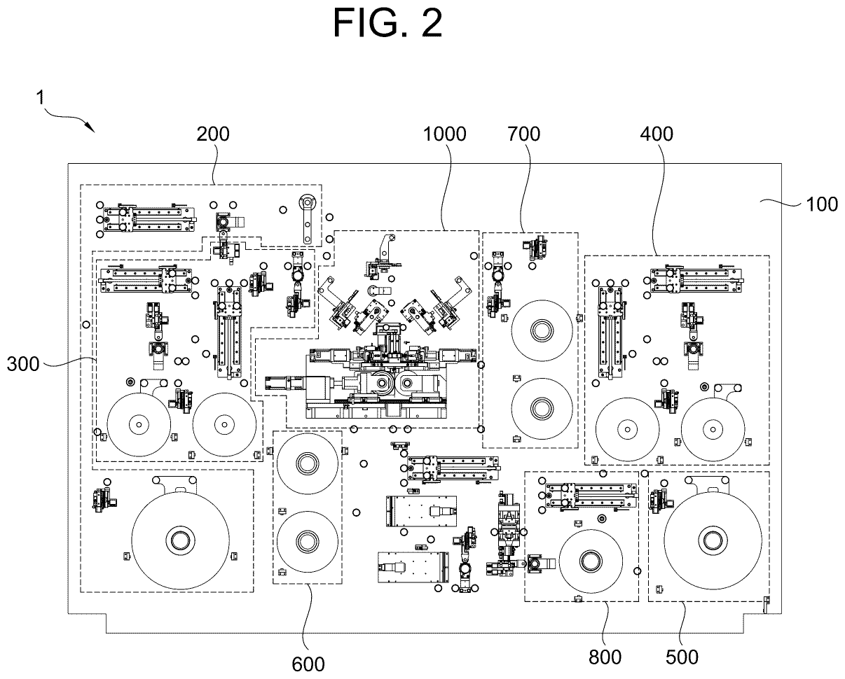

FIG. 2 is a front view of an apparatus 1 for manufacturing a secondary battery provided with a press bonding apparatus 1000 for an electrode foil of a lithium metal secondary battery according to an embodiment of the present disclosure.

The press bonding apparatus 1000 for the electrode foil of the lithium metal secondary battery according to an embodiment of the present disclosure may be provided in the apparatus for manufacturing the electrode foils of a lithium metal secondary battery.

First, the overall configuration of the apparatus 1 for manufacturing the electrode foils of the secondary battery will be described with reference to FIG. 2.

In an embodiment of the present disclosure, the apparatus for manufacturing the electrode foils of the lithium metal secondary battery may be divided depending on an object to be supplied or recovered (dotted line). The apparatus for manufacturing the electrode foils of the lithium metal secondary battery may include: a base metal foil supply unit 200 provided on a main frame 100 formed with a predetermined area in a vertical direction; a first lithium metal foil supply unit 300; a second lithium metal foil supply unit 400; a first film supply unit 600; a second film supply unit 700, a third film supply unit 800; a press bonding apparatus 1000; and an electrode foil winding unit 500.

The base metal foil supply unit 200 is configured to supply the base metal foil 20.

The lithium metal foil supply units 300 and 400 are composed of a pair and are configured to supply the lithium metal foil 30 or 40 attached to both surfaces of the base metal foil 20.

The first film supply unit 600 and the second film supply unit 700 are configured to supply a first film 51 and a second film 52, respectively, to the press bonding apparatus 1000, which will be described later. The first film and the second film are provided to prevent the foil from sticking to the surface of a roller when press-bonding the same through the roller and to ensure uniform press-bonding quality.

The press bonding apparatus 1000 is configured to attach the first lithium metal foil 30 and the second lithium metal foil 40 of a predetermined length to both surfaces of the base metal foil 20 in a press bonding space. Herein, the press bonding space refers to the space where a metal foil is supplied, cut, and attached to each other. The press bonding apparatus 1000 is configured to cut the lithium metal foil 30 and 40 at predetermined intervals and continuously attach the same to the base metal foil 20.

The third film supply unit 800 is configured to supply a third film 53 that may protect the electrode assembly 10 wound in the electrode foil winding unit 500.

The electrode foil winding unit 500 is configured to wind the electrode assembly 10 manufactured in the press bonding apparatus 1000.

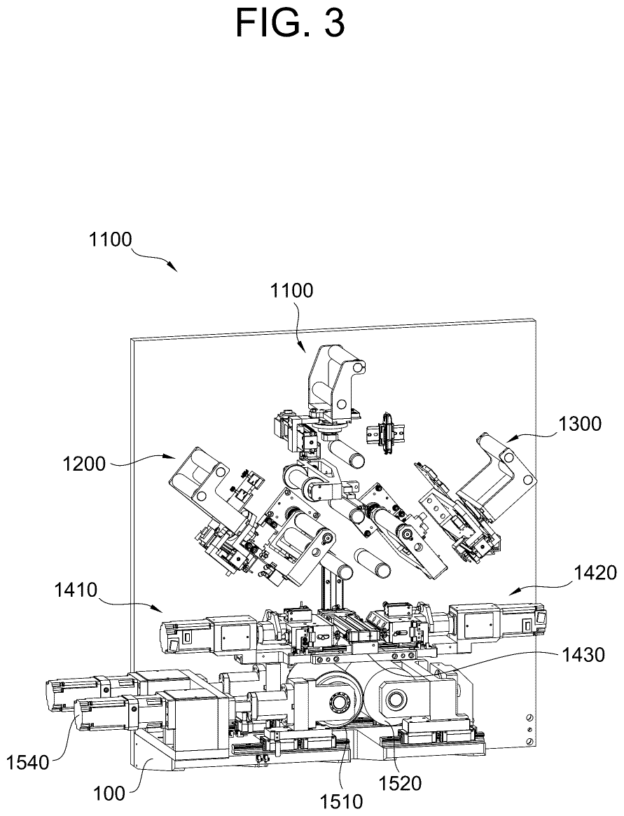

Hereinafter, the press bonding apparatus for the electrode foil of the lithium metal secondary battery according to an embodiment of the present disclosure will be described in detail with reference to FIGS. 3 to 8I.

The aforementioned configurations will be described below based on the layout illustrated in FIG. 2, but the position of each configuration is not limited. In other words, each element may be deformed and provided in various positions on the main frame 100 extending in a vertical direction.

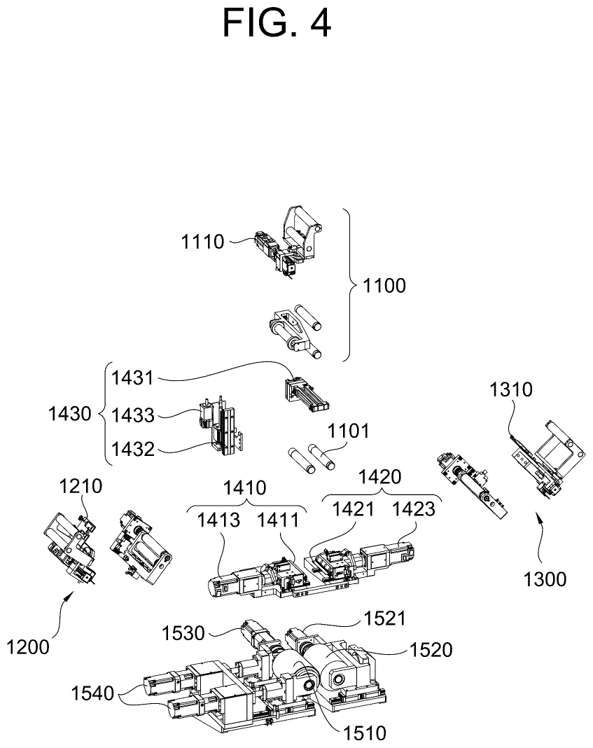

FIG. 3 is a perspective view of the press bonding apparatus 1000 according to an embodiment of the present disclosure. FIG. 4 is an exploded perspective view of the press bonding apparatus 1000 according to an embodiment of the present disclosure.

Referring to FIGS. 3 and 4, in this embodiment, the press bonding apparatus 1000 is configured to symmetrically attach a predetermined length of the lithium metal foil to both sides of the base metal foil 20.

The press bonding apparatus 1000 may include a base metal foil transfer unit 1100, a first transfer unit 1200, a second transfer unit 1300, a tack laminating module 1400, a die unit 1430, a main laminating press unit 1500, and a controller (not shown).

The base metal foil transfer unit 1100 is configured to transfer the base metal foil transferred from the base metal foil supply unit to the press bonding space at an appropriate speed. The base metal foil transfer unit 1100 may include a first sensor unit 1110 configured to measure the linear speed of the base metal foil.

The first transfer unit 1200 is configured to transfer the first lithium metal foil 30 to the press bonding space. The second transfer unit 1300 is configured to transfer the second lithium metal foil 40 to the press bonding space.

The first transfer unit 1200 and the second transfer unit 1300 may include dancers, driving rollers 1220 and 1320, and sensor units 1210 and 1310, respectively. The dancer is configured to maintain the tension of the transferred lithium metal foils 30 and 40 at a constant level.

The first driving roller 1220 and the second driving roller 1320 are configured to supply the lithium metal foil 30 and 40 at the same linear speed when attached to the base metal foil 20. A driving motor (not shown) may be connected to each of the driving rollers 1220 and 1320, and the linear speed of the lithium metal foil 30 and 40 may be adjusted according to the driving of the motor.

The second sensor unit 1210 and the third sensor unit 1310 are configured to measure the speed at which the lithium metal foil moves. However, although not illustrated, the first transfer unit 1200 and the second transfer unit 1300 may be configured to include a position adjustment unit for preventing misalignment and aligning the position of the supplied lithium metal foil, and may be configured to include at least one idle roller 1101 configured to transfer the foil along a desired path.

The tack laminating module 1400 is composed of a pair, each of which cuts each one of the lithium metal foils, and is configured to attach the front end of the cut lithium metal foil to the base metal foil 20. The tack laminating module 1400 is configured to attach (in other words, weld) the ends of the foils. Here, “attach” means making a state where the foils remain laminated to each other when no external force is applied.

Here, the term “front end” refers to an end of the lithium metal foil that proceeds when the lithium metal foil is cut by the tack laminating module 1400, which faces the main laminating press. In other words, the term “front end” refers to the leading end in the direction in which the lithium metal foil heads.

The tack laminating module 1400 may include a first tack laminating module 1410 and a second tack laminating module 1420 that are provided symmetrically left and right.

The first tack laminating module 1410 may include a first pushing block 1411 and a first tack laminating drive unit 1413.

The first pushing block 1411 is configured to adsorb the first lithium metal foil with an end and cut the first lithium metal foil with a corner of the end. The first pushing block 1411 may be provided with a first adsorption unit at an end. The first adsorption unit 1414 may include a plurality of adsorption holes and is configured to receive negative pressure from the outside and adsorb the first lithium metal foil 30 in close contact with the end. A first cutter 1412 may be provided at a lower corner of the end of the first pushing block 1411. The first cutter 1412 may be provided by cutting a corner of the pushing block at a predetermined angle so as to function as a cutter, or may be provided as a separate blade and coupled to the end of the first pushing block 1411.

The first pushing block 1411 may be configured to have a width greater than the width of the first lithium metal foil and be configured to stably adsorb or cut the first lithium metal foil. The first pushing block 1411 is configured to reciprocate in a horizontal direction on the frame of the first tack laminating module 1410.

The first tack drive unit 1413 may be configured to reciprocate the first pushing block 1411 horizontally. The movement amount of the first tack drive unit 1413 may be controlled by the controller.

The second tack laminating module 1420, like the first tack laminating module 1410, may include a second tack laminating drive unit 1423, a second pushing block 1421, a second cutter 1422, and a second adsorption unit 1424. The second tack laminating module 1420 may be provided to be spaced a predetermined distance apart in a horizontal direction from the first tack laminating module 1410 on an attachment area.

The first tack laminating module 1410 and the second tack laminating module 1420 are moved by their respective drive units to horizontally locate the ends of the first pushing block 1411 and the second pushing block 1421 to touch each other so that the lithium metal foil may be tack-laminated to the base metal foil 20.

The die unit 1430 is configured to cut the lithium metal foil 30 and 40 in association with the first tack laminating module 1410 and the second tack laminating module 1420. The die unit 1430 is moved to a cutting position when the lithium metal foil 30 and 40 is cut, and may be moved to a standby position to prevent interference with the tack laminating modules 1410 and 1420 when the lithium metal foil 30 and 40 is tack-laminated.

The die unit 1430 may be configured to include a die block 1431 and a linear guide 1432.

The die block 1431 may be configured to move in a vertical direction on the main frame 100. The die block 1431 may be connected to the main frame through the linear guide 1432. A die block drive unit 1433 may be driven to reciprocate the die block 1431 between the standby position and the cutting position.

Blade accommodation grooves formed in a horizontal direction may be provided on both sides of the die block 1431 so that the first cutter 1412 and the second cutter 1422 of the tack laminating module 1400 may be inserted. The die block 1431 may be composed of a pair disposed in a horizontal direction. An elastic unit 1512 may be provided between the pair of die blocks 1431 and is configured to absorb shock when force is applied in a lateral direction.

The die block 1431 may ascend to a height where interference does not occur when the tack laminating modules 1410 and 1420 tack laminate the metal foil in the standby position. Thereafter, the tack laminating module 1400 may descend back to the cutting position when the lithium metal foil is cut after tack laminating is completed.

The main laminating press unit 1500 is configured to press and attach the lithium metal foil 30 and 40 and the base metal foil 20 whose front ends are tack-laminated through a pair of the tack laminating modules 1410 and 1420 in a thickness direction. The base metal foil 20 and the lithium metal foil 30 and 40 that have passed through the main laminating press unit 1500 are completely attached to each other. In other words, the main laminating press unit 1500 can achieve pressure-activated lamination of the foils.

The main laminating press unit 1500 may include a hard roller 1520, an elastic roller 1510, and a rotation drive unit 1530.

The hard roller 1520 has a cylindrical or cylindrical shape and may have a hard outer surface. The hard roller 1520 is an idle roller and may be configured to freely rotate by external force. A rotation center axis of the hard roller 1520 may be fixed on the main frame. In other words, the hard roller 1520 is configured to rotate while its center axis is fixed.

The elastic roller 1510 is configured to create an electrode assembly by pressing the foil while reducing the gap with the hard roller 1520. The outer peripheral surface of the elastic roller 1510 may be coated with an elastic material.

As an example, the elastic roller 1510 may be configured to move toward the hard roller 1520 by a pressure drive unit 1540. The pressure drive unit 1540 exerts an appropriate force and transmits the same to the elastic roller 1510 by the controller to be described later. Additionally, the elastic roller 1510 is connected to the rotation drive unit 1530 and is configured to receive rotational force. When the rotation drive unit 1530 rotates while the elastic roller 1510 and the hard roller 1520 are tightly pressing the foil, the hard roller 1520 also rotates.

In an embodiment of the present disclosure, the main laminating press unit 1500 is provided asymmetrically for the following reason.

First, when the main laminating press unit 1500 is provided with a pair of the elastic rollers 1510, the portion where stress is concentrated in each of the elastic rollers 1510 is deformed and uneven force is transmitted to the foil being pressed. As a result, a large number of horizontal wrinkles and cracks occur in the electrode assembly.

Second, when the main laminating press unit 1500 is provided with a pair of the hard rollers 1520, the stress generated during press bonding may not be distributed, and the electrode assembly loses uniformity due to bubbles or the like.

Third, even when the elastic roller 1510 and the hard roller 1520 are provided, in the case where the hard roller 1520 is actively driven, the stress on the lithium metal foil in contact with the hard roller 1520 increases rapidly, thereby causing deformation. As a result, horizontal wrinkles or cracks occur, and in severe cases, the lithium metal foil may break.

Accordingly, the uniformity of the electrode assembly may be improved by actively rotating and attaching the elastic roller 1510, which undergoes appropriate deformation in order to properly press and attach the foil.

The controller (not shown) controls the driving elements based on the information received from the first sensor unit 1110, the second sensor unit 1210, the third sensor unit 1310, and an encoder 1521. In an embodiment of the present disclosure, the controller may appropriately control the rotation drive unit 1530 based on the information received particularly from the first sensor unit 1110 and the encoder 1521.

In addition, the controller may adjust the rotation speed of the first driving motor and the second driving roller 1320 based on the linear speed information of each of the lithium metal foil. The controller may control the tack laminating module 1400 to periodically cut and tack laminate the lithium metal foil 30 and 40.

The controller may reduce the speed of the driving rollers 1220 and 1320 or stop supply for a predetermined time to complete cutting of the lithium metal foil and form a gap d in the transport direction in the electrode assembly. In this connection, a buffer and dancer may operate to maintain the operation of the lithium metal foil supply unit.

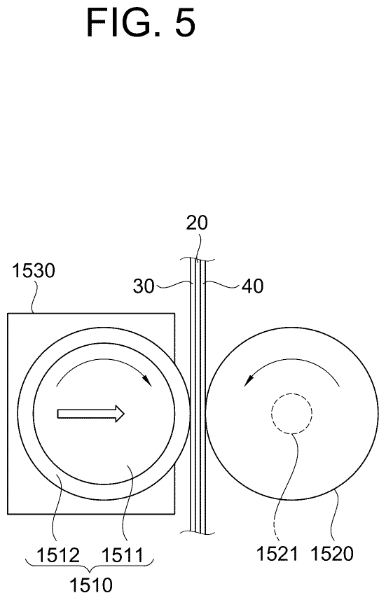

FIG. 5 is a conceptual diagram illustrating the operation of the elastic roller 1510 and the hard roller 1520 in the press bonding apparatus 1000 for the electrode foil of the lithium metal secondary battery according to an embodiment of the present disclosure.

The elastic roller 1510 presses the first lithium metal foil 30, the base metal foil 20, and the second lithium metal foil 40 in a thickness direction by the pressure drive unit 1540, and the second lithium metal foil is supported by the hard roller 1520. As the elastic roller 1510 presses the foil in the thickness direction, the foils are attached to each other. In this connection, the foils move according to the frictional force in the contact area of the elastic roller 1510, and the hard roller 1520 also rotates as the foils move. In other words, the hard roller 1520 rotates passively, and the elastic roller 1510 rotates actively.

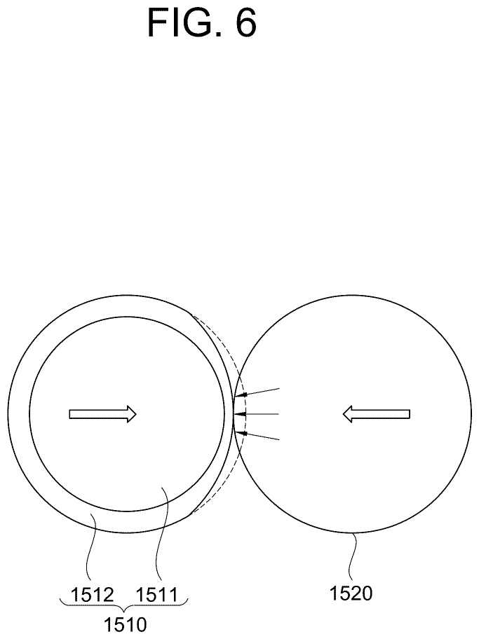

FIG. 6 is a conceptual diagram illustrating the deformation of the elastic roller 1510 in an embodiment of the present disclosure.

The elastic roller 1510 may be provided with a cylinder or cylindrical roller core 1511 at its center. The elastic roller 1510 may be provided with the elastic unit 1512 having a predetermined thickness along the outer peripheral surface of the roller core 1511. The elastic unit 1512 is made of a material with a certain amount of elasticity and may be configured to be deformed by a certain amount according to an external force. For example, the elastic unit 1512 may be made of a rubber-based material or a polymer-based material.

The elastic roller 1510 and the hard roller 1520 may be configured to have similar outer diameters when there is no external force. However, the hard roller 1520 may be configured with a curvature corresponding to the curvature of the elastic roller 1510 that changes when pressed. In this connection, the hard roller 1520 may have a larger outer diameter than the elastic roller 1510.

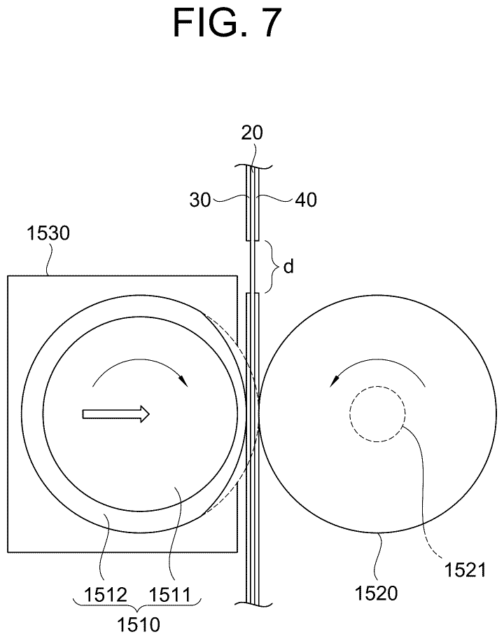

FIG. 7 is a conceptual diagram illustrating the speeds of foils, elastic rollers 1510, and hard rollers in a pressing area in an embodiment of the present disclosure.

The hard roller 1520 is provided with the encoder 1521 to obtain information related to rotation. When the roller moves, the linear speed on the side surface is proportional to the angular speed, but in the case of the elastic roller 1510, the linear speed on the surface is not proportional to the angular speed due to deformation. Accordingly, in order to accurately measure the linear speed at a main laminating portion, information is collected from the hard roller 1520 whose outer diameter does not change and the relationship between speed and angular speed is maintained.

The controller may control the transfer speed of the lithium metal foil in the first transfer unit 1200 and the second transfer unit 1300 based on the linear speed VI of the base metal foil. In addition, the controller may control the rotation drive unit 1530 based on the linear speed of the base beta foil. The rotation drive unit 1530 is composed of a servo motor and is configured to follow input. In this connection, since the hard roller 1520 is finally rotated by the rotation drive unit 1530, the controller calculates the linear speed on the outer peripheral surface of the hard roller based on the angular speed obtained from the encoder 1521. The controller feedback controls the rotation drive unit 1530 so that the linear speed on the outer peripheral surface of the hard roller 1520 becomes the same as the linear speed of the base metal foil. In other words, even when the exact linear speed may not be measured/calculated on the deformed outer peripheral surface of the elastic roller 1510, the linear speed of the outer peripheral surface may be measured/calculated through the correctively rotating hard roller 1520.

Since the linear speed of the foils supplied under the control of the controller and the linear speed at the press bonding portion are maintained the same, a uniformly press-bonded electrode assembly may be manufactured.

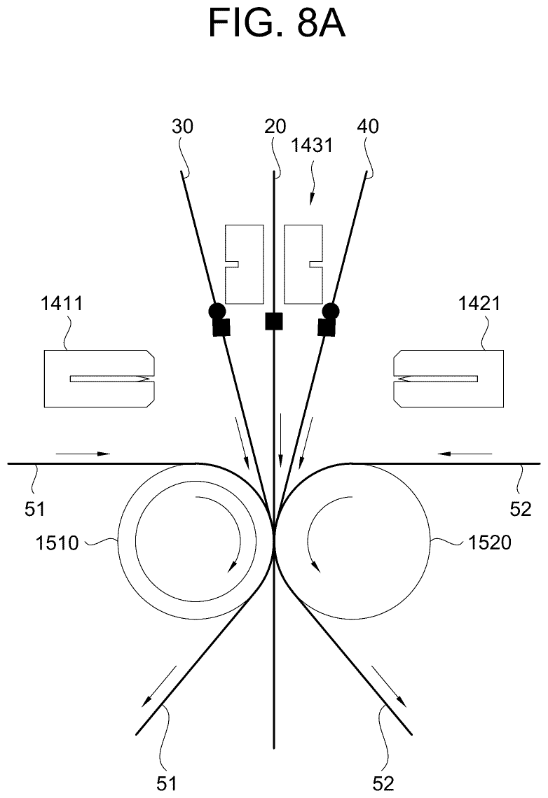

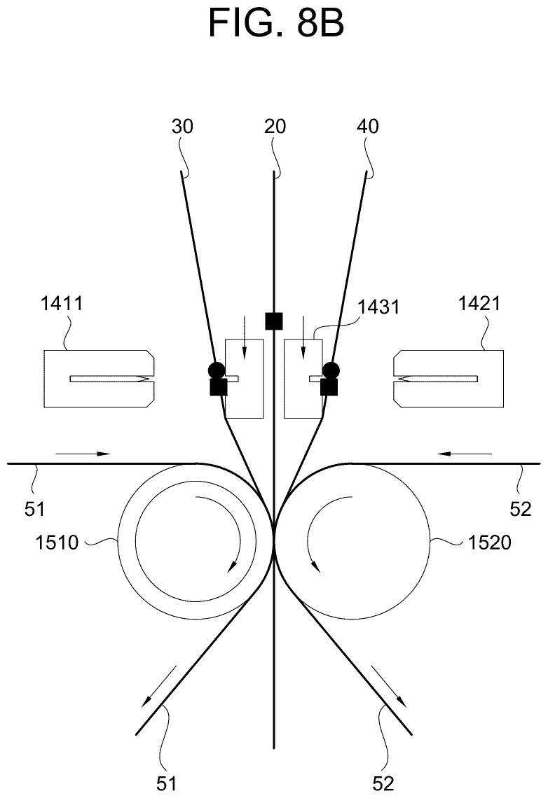

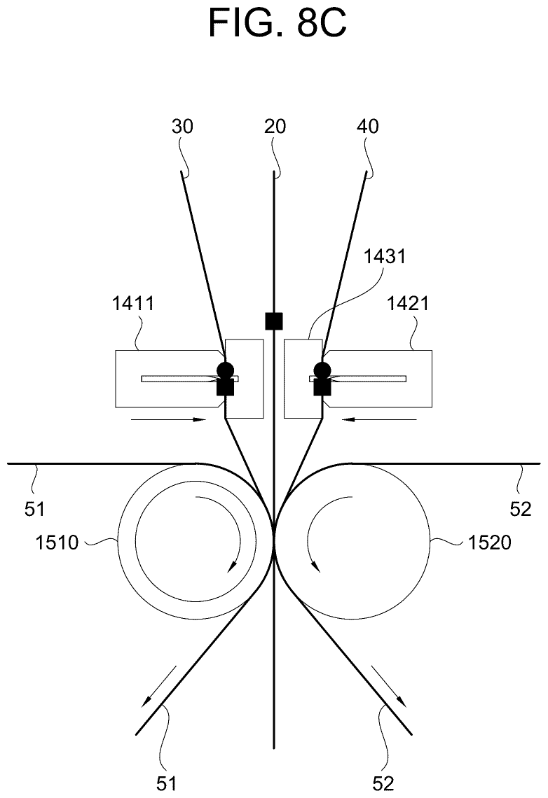

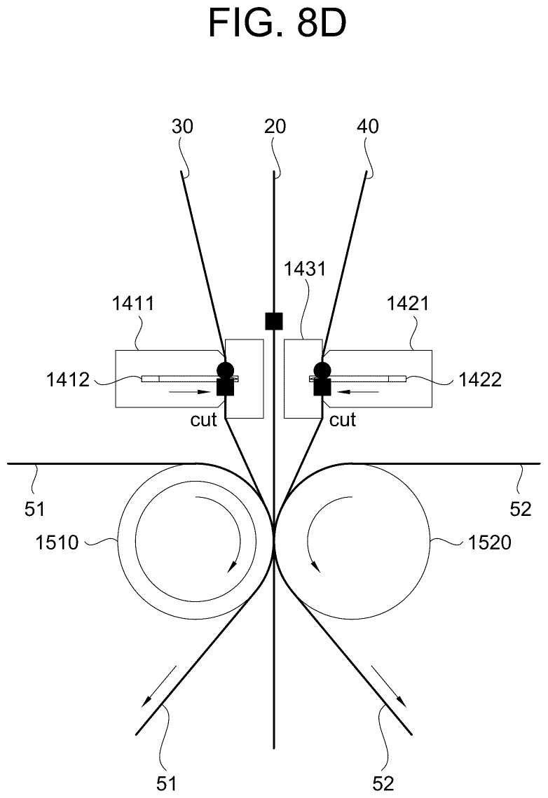

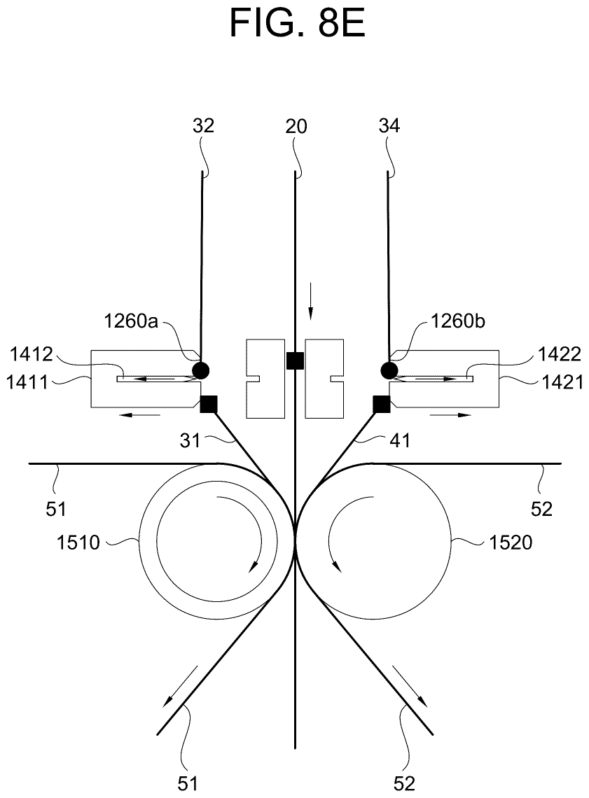

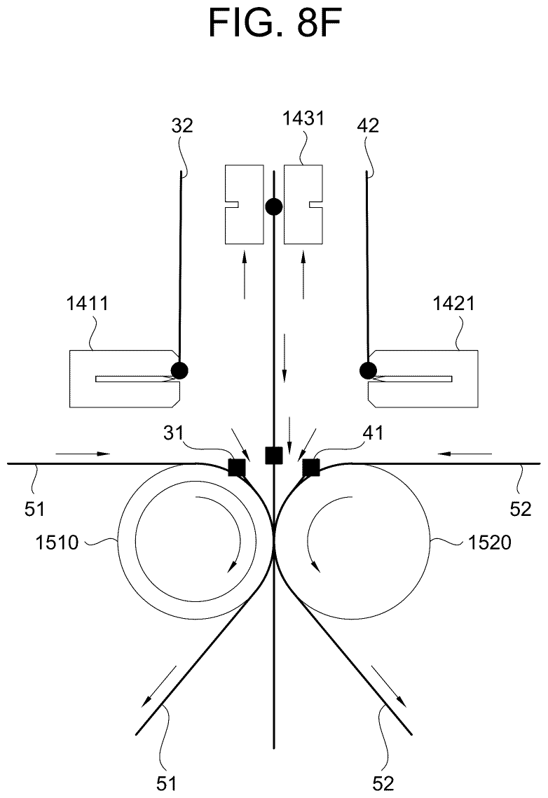

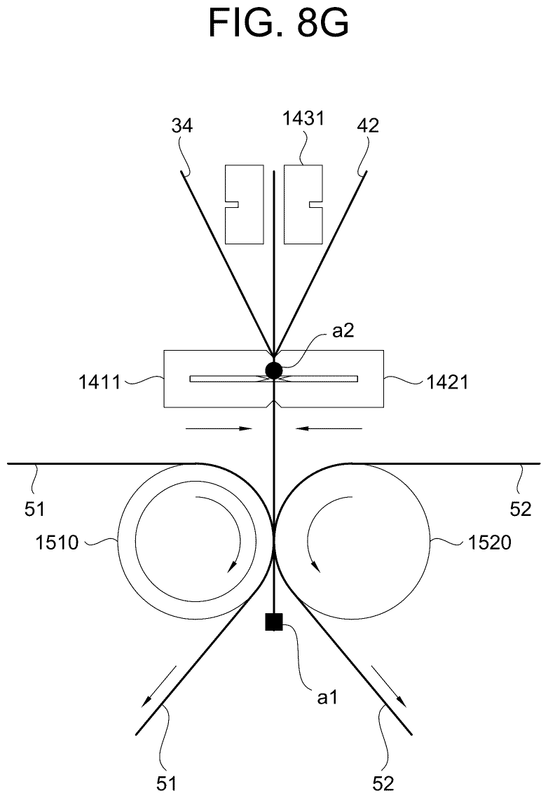

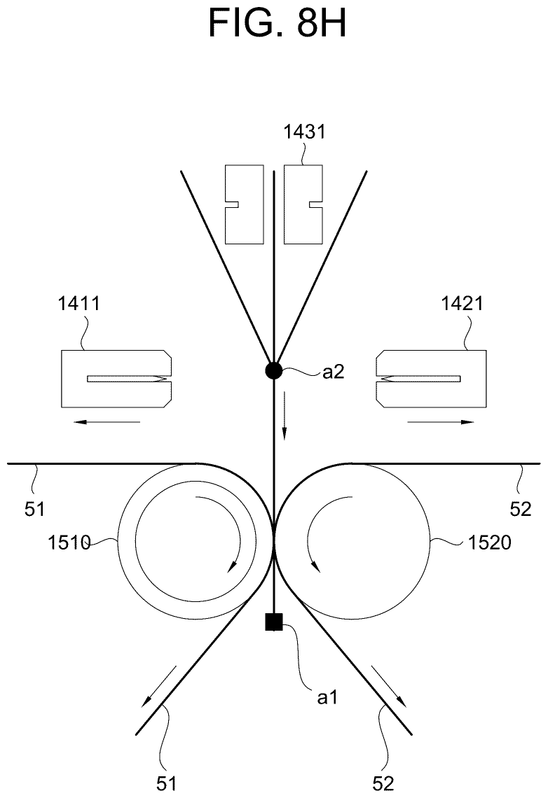

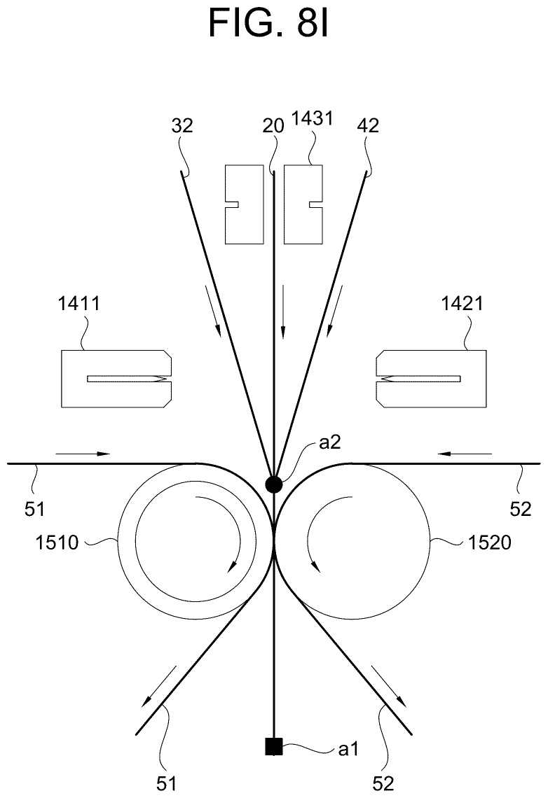

Hereinafter, the operation of the press bonding apparatus 1000 according to this modification will be described with reference to FIGS. 8A to 8I. The operations below may be controlled by the controller. For convenience of explanation, the point attached to the rear end of the preceding lithium metal foils is indicated by a square symbol, and the point attached to the front end of the proceeding lithium metal foils is indicated by a circular symbol.

FIGS. 8A to 8I are conceptual diagrams illustrating the operation of the press bonding apparatus 1000 according to this modification.

First, referring to FIG. 8A, the first lithium metal foil 30, the base metal foil 20, and the second lithium metal foil 40 are continuously supplied to the elastic roller 1510 and the hard roller 1520 with their front sides tack-laminated. Metal foils may be attached while passing through the elastic roller 1510 and the hard roller 1520. In the press bonding process described below, the first film 51 may continuously pass through the outer peripheral surface of the elastic roller 1510, and the second film 52 may continuously pass through the outer peripheral surface of the hard roller 1520.

In this connection, the first tack laminating module 1410, the second tack laminating module 1420, and the die block 1431 may wait at the standby position.

Referring to FIG. 8B, the die block 1431 descends to the cutting position without interfering with the transfer of the base metal foil. In this connection, the height of the die block 1431 may be aligned to a position where the first cutter 1412 and the second cutter 1422 may be inserted into the blade accommodation groove.

Referring to FIG. 8C, the first pushing block 1411 and the second pushing block 1421 are moved in a direction closer to each other and come into close contact with both sides of the die block 1431. In this connection, the adsorption units 1414 and 1424 of the first pushing block 1411 and the second pushing block 1421 run to adsorb and secure the first lithium metal foil 30 and the second lithium metal foil 40. Even when the first pushing block 1411 and the second pushing block 1421 press excessively on the die block 1431, the die block 1431 may be retracted a certain distance, thereby preventing damage to the lithium metal foils 30 and 40.

Referring to FIG. 8D, cutter drive units are then driven to move the first cutter 1412 and the second cutter 1422 forward. The first lithium metal foil 30 and the second lithium metal foil 40 are cut by moving the first cutter 1412 and the second cutter 1422.

The operations of FIGS. 8B to 8D may be performed quickly. When such a cutting operation is performed on the lithium metal foil, the rotation of the elastic roller 1510 may be maintained.

Referring to FIG. 8E, the first pushing block 1411 and the second pushing block 1421 are then returned to their original positions. In this connection, the front end of the proceeding first lithium metal foil 32 remains fixed to the adsorption portion 1414 of the first pushing block 1411. Similarly, the front end of the proceeding second lithium metal foil 44 remains fixed to the adsorption portion 1424 of the second pushing block 1421. In this state, the rear end of the preceding first lithium metal foil 31 and the rear end of the preceding second lithium metal foil 41 may maintain their postures by their own strength and are continuously drawn between the hard roller 1520 and the elastic roller 1510.

Referring to FIG. 8F, a preparatory operation for tack laminating the metal foils 32 and 42 is then performed. The die block 1431 may ascend to a standby position where the pushing blocks 1411 and 1421 are not contacted when moving horizontally. Simultaneously, the elastic roller 1510 and the hard roller 1520 run to achieve main laminating to a certain area of the preceding lithium metal foils 31 and 41. In this connection, the base metal foil 20 is also supplied to the main laminating press unit 1500 while maintaining the linear speed.

Referring to FIG. 8G, when the rear ends of the preceding lithium metal foils 31 and 41 and the front ends of the proceeding lithium metal foils 32 and 42 are spaced apart by a preset length, the proceeding lithium metal foils 32 and 42 and the base metal foil 20 are tack-laminated (see a1 and a2). In this connection, the first lithium metal foil 32 fixed by the first pushing block 1411 and the second lithium metal foil 44 fixed by the second pushing block 1421 are in close contact with the base metal foil 20 and are pressed, forming a tack laminate.

Referring to FIG. 8H, the first pushing block 1411 and the second pushing block 1421 are then retreated and returned to their original positions.

Thereafter, referring to FIG. 8I, the first driving roller and the second driving roller are operated to main laminate the proceeding lithium metal foils 32 and 42 so that the linear speed of the lithium metal foils is adjusted to be equal to the supply linear speed of the base metal foil.

The stages described above with reference to FIGS. 8A to 8I may be repeatedly performed when each unit electrode assembly is generated.

As described above, the press bonding apparatus for the electrode foil of the lithium metal secondary battery according to an embodiment of the present disclosure can precisely adjust the supply speed and rolling speed while preventing damage to the metal foils, thereby improving the uniformity and coating flatness of the electrode foils.

What is claimed is:

1. A press bonding apparatus for an electrode foil of a lithium metal secondary battery, the apparatus comprising:
a base metal transfer unit configured to transfer a base metal foil to a press bonding space;
a first transfer unit configured to transfer a first lithium metal foil to the press bonding space;
a second transfer unit configured to transfer a second lithium metal foil to the press bonding space;
a hard roller provided on one side of the press bonding space; and
an elastic roller provided on the other side of the press bonding space,
wherein the hard roller and the elastic roller press-bonds the base metal foil, the first lithium metal foil, and the second lithium metal foil.

2. The apparatus of claim 1, wherein the elastic roller comprises a roller core and a coating unit provided on an outer peripheral surface of the roller core.

3. The apparatus of claim 2, further comprising a pressing drive unit configured to press the elastic roller toward the hard roller.

4. The apparatus of claim 3, further comprising an encoder configured to measure the rotation of the hard roller.

5. The apparatus of claim 4, further comprising a rotation drive unit configured to rotate the elastic roller.

6. The apparatus of claim 5, wherein the hard roller is configured to freely rotate.

7. The apparatus of claim 6, wherein the base metal transfer unit comprises:
a first sensor unit configured to measure a moving speed of the base metal foil; and
a controller configured to control the rotation drive unit based on a value received from the first sensor unit.

8. The apparatus of claim 7, wherein the controller is configured to control the rotation drive unit based on the value received from the first sensor unit and a value received from the encoder.

9. The apparatus of claim 8, further comprising a tack laminating module configured to cut the first lithium metal foil transferred from the first transfer unit and the second lithium metal foil transferred from the second transfer unit and tack laminate ends of the proceeding lithium metal foil to both surfaces of the base metal foil.

10. The apparatus of claim 9, wherein the tack laminating module is composed of a pair, is symmetrical on the left and right, and includes blades that are each reciprocatable.

11. The apparatus of claim 10, wherein the tack laminating module is configured to cut the first lithium metal foil and the second lithium metal foil to a predetermined length.

12. The apparatus of claim 11, wherein the tack laminating module is controlled to tack laminate front ends of the proceeding first lithium metal foil and the proceeding second lithium metal foil at a predetermined distance apart from rear ends of the preceding first lithium metal foil and the second lithium metal foil.
